(19) United States
(12) Patent Application Publication
(10) Pub. No.: US 2018/0365468 A1
(43) Pub. Date: Dec. 20, 2018

(54) FINGERPRINT RECOGNITION COMPONENT, DISPLAY DEVICE AND FINGERPRINT RECOGNITION METHOD

(71) Applicant: BOE TECHNOLOGY GROUP CO., LTD., Beijing (CN)

(72) Inventors: Pengpeng WANG, Beijing (CN); Xue DONG, Beijing (CN); Jing LV, Beijing (CN); Haisheng WANG, Beijing (CN); Chunwei WU, Beijing (CN); Xiaoliang DING, Beijing (CN); Yingming LIU, Beijing (CN); Yanling HAN, Beijing (CN); Wei LIU, Beijing (CN); Rui XU, Beijing (CN); Changfeng LI, Beijing (CN); Lijun ZHAO, Beijing (CN); Yanan JIA, Beijing (CN); Yuzhen GUO, Beijing (CN)

(21) Appl. No.: 15/736,820

(22) PCT Filed: Apr. 17, 2017
(86) PCT No.: PCT/CN2017/080771

§ 371 Date: Dec. 15, 2017

(30) Foreign Application Priority Data
May 31, 2016 (CN) 201610378188.2

(51) Int. Cl. G06K 9/00; G02F 1/1335; G02F 1/133; G09G 3/36

(52) U.S. Cl. CPC G06K 9/0004; G02F 1/133603; G09G 3/36; G02F 1/133512; G02F 1/13306

(57) ABSTRACT

The present disclosure provides a fingerprint recognition component, a display device and a fingerprint recognition method. The fingerprint recognition component according to the present disclosure comprises: a light emitting unit configured to emit light to a finger; a light sensing unit configured to receive light emitted by the light emitting unit and reflected by the finger, and generate a sensing signal based on an intensity of received light; a modulation signal generation unit configured to generate a modulation signal having a modulation frequency, and control the light emitting unit to emit light flickeringly at the modulation frequency by using the modulation signal; and a demodulation unit connected to the light sensing unit and configured to demodulate the sensing signal in accordance with the modulation frequency.

### RELATED APPLICATION

The present application is the U.S. national phase entry of PCT/CN2017/080771, with an international filing date of Apr. 17, 2017, which claims the benefit of Chinese Patent Application No. 201610378188.2, filed on May 31, 2016, the entire disclosures of which are incorporated herein by reference.

### FIELD

The present disclosure relates to the field of fingerprint recognition technology, and specifically to a fingerprint recognition component and method, as well as a display device.

### BACKGROUND

With the development of technology, many display devices such as mobile phones, tablet computers and the like began to involve fingerprint recognition function.

However, due to the limitation by the size, performance and the like of photosensitive devices in the light sensing units, the sensing signal (photocurrent) generated thereby is generally very small. In contrast, noise signals generated by the ambient light, leakage current, parasitic capacitance, circuit interference, etc. have greater intensities. Therefore, the actual sensing signal has a low signal-to-noise ratio and the noise signal is difficult to remove, resulting in low accuracy of fingerprint recognition.

### SUMMARY

It is an objective of the present disclosure to provide improved fingerprint recognition component, display device and fingerprint recognition method.

According to an aspect of the present disclosure, there is provided a fingerprint recognition component, comprising:

a light emitting unit configured to emit light to a finger;

a light sensing unit configured to receive light emitted by the light emitting unit and reflected by the finger, and generate a sensing signal based on an intensity of received light;

a modulation signal generation unit configured to generate a modulation signal having a modulation frequency, and control the light emitting unit to emit light flickeringly at the modulation frequency by using the modulation signal; and

a demodulation unit connected to the light sensing unit and configured to demodulate the sensing signal in accordance with the modulation frequency.

According to some embodiments, the demodulation unit comprises: a DC blocking subunit, an input terminal of the DC blocking subunit connected to the light sensing unit; a demodulation subunit, an input terminal of the demodulation subunit connected to an output terminal of the DC blocking subunit; and a low pass filter subunit, an input terminal of the low pass filter subunit connected to an output terminal of the demodulation subunit.

According to some embodiments, the light sensing unit is a light sensing unit configured to generate a sensing current signal. In such embodiments, the fingerprint recognition component further comprises: a current-voltage conversion unit connected between the light sensing unit and the demodulation unit.

According to some embodiments, the modulation signal generation unit is further connected to the demodulation unit, and is further configured to transmit the modulation signal to the demodulation unit as a demodulation carrier signal.

According to some embodiments, the modulation frequency is above 1 kHz.

According to another aspect of the present disclosure, there is provided a display device comprising any fingerprint recognition component described above.

According to some embodiments, the display device comprises: a liquid crystal display panel including a plurality of pixels, wherein the light sensing unit is disposed in the liquid crystal display panel; a backlight unit disposed outside a light incident surface of the liquid crystal display panel, wherein the backlight unit is the light emitting unit. In such embodiments, the modulation signal generation unit is connected to the backlight unit and is configured to drive the backlight unit to emit light using the modulation signal generated by the modulation signal generation unit.

According to some embodiments, the light sensing unit is disposed at an interval between adjacent pixels.

According to some embodiments, the liquid crystal display panel comprises an array substrate and a color film substrate, and the light sensing unit is disposed in the array substrate or the color film substrate.

According to some embodiments, the display device comprises: a light emitting diode display panel including a plurality of pixels, wherein the light sensing unit is disposed in the light emitting diode display panel.

According to some embodiments, each of the pixels includes a light emitting diode and a driving unit for driving the light emitting diode to emit light. The driving unit comprises a switching thin film transistor connected in series with the light emitting diode. Current is allowed to flow through the light emitting diode when the switching thin film transistor is turned on. The current is not allowed to flow through the light emitting diode when the switching thin film transistor is turned off. The modulation signal generation unit is connected to a gate of the switching thin film transistor.

According to some embodiments, the light sensing unit is disposed at an interval between adjacent pixels.

According to some embodiments, the light emitting diode display panel comprises an array substrate and an opposite substrate, and the light sensing unit is disposed in the array substrate or the opposite substrate.

According to some embodiments, the display device comprises a plurality of pixels, each including the light emitting unit and a driving unit for driving the light emitting unit to emit light. The driving unit comprises a switching device configured to selectively connect or disconnect the light emitting unit to or from other portions of the driving unit. The modulation signal generation unit is connected to the switching device and is configured to control on or off of the switching device using the modulation signal generated by the modulation signal generation unit.

According to a further aspect of the present disclosure, there is provided a fingerprint recognition method comprising:

making a light emitting unit emit light to a finger in a flickering manner at a modulation frequency;

receiving, by a light sensing unit, light emitted by the light emitting unit and reflected by the finger;

generating, by the light sensing unit, a sensing signal based on an intensity of received light; and

demodulating the sensing signal, and performing fingerprint recognition based on the demodulated sensing signal.

In the fingerprint recognition component according to the present disclosure, the modulation signal generation unit can control the light emitting unit to emit light flickeringly at a specific frequency by means of the generated modulation signal, thus the light reflected by the finger which is received by the light sensing unit also flickers at the modulation frequency. Therefore, the sensing signal generated by the reflected light also undergoes modulation by the modulation frequency. On the other hand, since the noise signal generated by the ambient light, circuit or the like is independent of the light emission condition of the light emitting unit, it has no specific frequency characteristic (which means that it does not undergo modulation). Accordingly, after the sensing signal is demodulated, the noise signal can be effectively removed therefrom, thereby realizing noise separation, increasing the signal-to-noise ratio, and achieving more accurate fingerprint recognition.

### BRIEF DESCRIPTION OF DRAWINGS

FIG. 1 is a schematic sectional view of a display device having fingerprint recognition function;

FIG. 2 is a schematic view showing the principle of modulation and demodulation;

FIG. 3 is a block diagram showing the composition of a fingerprint recognition component according to embodiments of the present disclosure;

FIG. 4 is a schematic structural view of a current-voltage conversion unit in a fingerprint recognition component according to embodiments of the present disclosure;

FIG. 5 is a schematic view showing the operating principle of a DC blocking subunit in a fingerprint recognition component according to embodiments of the present disclosure;

FIG. 6 is a schematic structural view of a DC blocking subunit in a fingerprint recognition component according to embodiments of the present disclosure;

FIG. 7 is a schematic structural view of a demodulation subunit in a fingerprint recognition component according to embodiments of the present disclosure;

FIG. 8 is a schematic structural view of a low pass filter subunit in a fingerprint recognition component of embodiments of the present disclosure;

FIG. 9 is a schematic view showing the distribution of light sensing units in a display device according to embodiments of the present disclosure;

FIG. 10 is a structural diagram of a driving unit of a pixel in a display device according to embodiments of the present disclosure;

FIG. 11 is a driving timing diagram of a driving unit of a pixel in a display device according to embodiments of the present disclosure;

FIG. 12 is a circuit diagram of a shift register generating an EM signal in a display device according to embodiments of the present disclosure;

FIG. 13 is a driving timing diagram of a shift register generating an EM signal in a display device according to embodiments of the present disclosure;

FIG. 14 is a view showing the distribution of noise with frequency in a circuit;

FIG. 15 is a flow chart of a fingerprint recognition method according to embodiments of the present disclosure.

### DETAILED DESCRIPTION

To enable those skilled in the art to better understand the technical solutions of the present disclosure, the present disclosure will be further described below in detail with reference to the accompanying drawings and specific embodiments.

In the drawings of the present disclosure, the following reference numerals are used:

1 light sensing unit;

71 liquid crystal display panel;

72 backlight unit;

91 valley;

92 ridge

K1 first switch;

K2 second switch;

K3 third switch;

K4 fourth switch;

R1 first resistor;

R2 second resistor;

R3 third resistor;

R4 fourth resistor;

M1 first thin film transistor;

M2 second thin film transistor;

M3 third thin film transistor;

M4 fourth thin film transistor;

M5 fifth thin film transistor;

M6 sixth thin film transistor;

T thin film transistor;

T1 first transistor;

T2 second transistor;

T3 third transistor;

T4 fourth transistor;

T5 fifth transistor;

T6 sixth transistor;

T7 seventh transistor;

T8 eighth transistor;

T9 ninth transistor;

T10 tenth transistor;

T11 eleventh transistor;

C capacitor;

C1 first capacitor;

C2 second capacitor;

C3 third capacitor;

OLED light emitting diode;

Read read line;

Gate gate line.

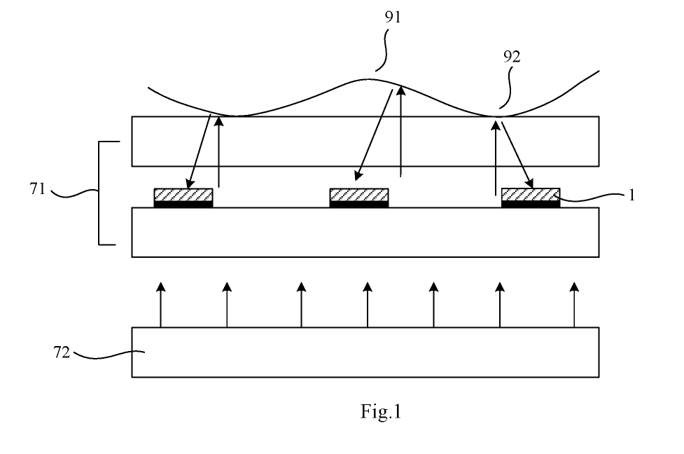

A conventional fingerprint recognition method is as shown in FIG. 1. A display panel (a liquid crystal display panel 71 is taken as an example, and a backlight unit 72 is further provided outside a light incident surface thereof) comprises a plurality of light sensing units 1. When a finger presses the display panel, light emitted from the display panel can be reflected back to the light sensing units 1. Since a valley 91 and a ridge 92 of the fingerprint reflect light differently, sensing signals (such as photocurrent) generated by the light sensing units 1 to which the valley 91 and the ridge 92 correspond are different. A pattern of the fingerprint can be determined by comparing the sensing signals of the individual light sensing units.

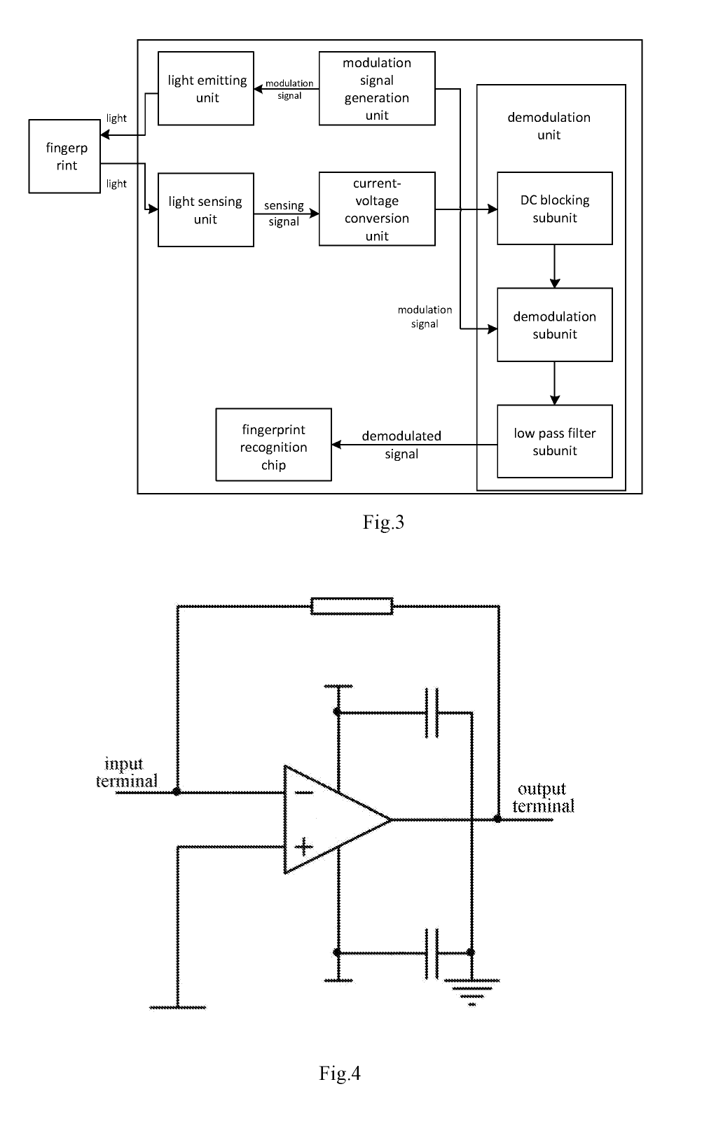

As shown in FIG. 3, an embodiment of the present disclosure provides a fingerprint recognition component comprising: a light emitting unit configured to emit light to a finger; a light sensing unit configured to receive light emitted by the light emitting unit and reflected by the finger, and generate a sensing signal based on the intensity of received light; a modulation signal generation unit configured to generate a modulation signal having a modulation frequency and control the light emitting unit to emit light flickeringly at the modulation frequency by using the modulation signal; and a demodulation unit connected to the light sensing unit and configured to demodulate the sensing signal in accordance with the modulation frequency.

The fingerprint recognition component of the present embodiment comprises at least one light emitting unit capable of emitting light to a finger, and a plurality of light sensing units 1 disposed at different positions and capable of generating different sensing signals depending on different illumination intensities. Since a valley 91 and a ridge 92 of the fingerprint reflect light differently, sensing signals generated by the light sensing units 1 corresponding to the positions of the valley 91 and the ridge 92 of the fingerprint respectively are also different. It can be determined to which parts of the fingerprint the light sensing units 1 correspond by analyzing and comparing the sensing signals generated by the light sensing units 1, thereby obtaining a fingerprint pattern and realizing fingerprint recognition.

Unlike a conventional fingerprint recognition component, the fingerprint recognition component of the present embodiment further comprises a modulation signal generation unit configured to generate a modulation signal (or a modulation carrier wave) having a modulation frequency (i.e. a specific frequency). For example, the modulation signal may be a square wave signal having a modulation frequency, but the modulation signal is not limited thereto. The modulation signal generated by the modulation signal generation unit is used to control the light emitting unit so that the light emitting unit can emit light flickeringly in accordance with the modulation frequency when fingerprint recognition is to be performed. Accordingly, the fingerprint recognition component of the present embodiment further comprises a plurality of demodulation units configured to demodulate the sensing signals generated by the respective light sensing units. Obviously, the demodulation unit should demodulate the sensing signal according to the modulation frequency.

Of course, the above modulation signal generation unit may have a variety of different forms, such as a square wave generation circuit, a driving chip, and the like, which will not be described here in detail. At the same time, the demodulation unit should be further connected to a fingerprint recognition chip so that the fingerprint recognition chip can perform analysis and processing of the demodulated signal to finally obtain the fingerprint, which will not be described here in detail.

In the fingerprint recognition component of the present embodiment, the modulation signal generation unit can control the light emitting unit to emit light flickeringly at a specific frequency by means of the generated modulation signal, thus the light reflected by the finger which is received by the light sensing unit also flickers at the modulation frequency. Therefore, the sensing signal generated by the reflected light also undergoes modulation by the modulation frequency. On the other hand, since the noise signal generated by the ambient light, circuit or the like is independent of the light emission condition of the light emitting unit, it has no specific frequency characteristic (which means that it does not undergo modulation). Accordingly, after the sensing signal is demodulated, the noise signal can be effectively removed therefrom, thereby realizing separation of noise, increasing the signal-to-noise ratio, and achieving more accurate fingerprint recognition.

The basic principle of modulation and demodulation will be specifically introduced below. In order to make the description of the principle clearer, a sine wave is used as a modulation carrier wave. It should be understood that other types of modulation carrier waves (e.g. the square wave of the present embodiment) may be changed into the form of a sine wave by Fourier expansion. At the same time, the following original signal to be modulated employ a signal that changes significantly over time.

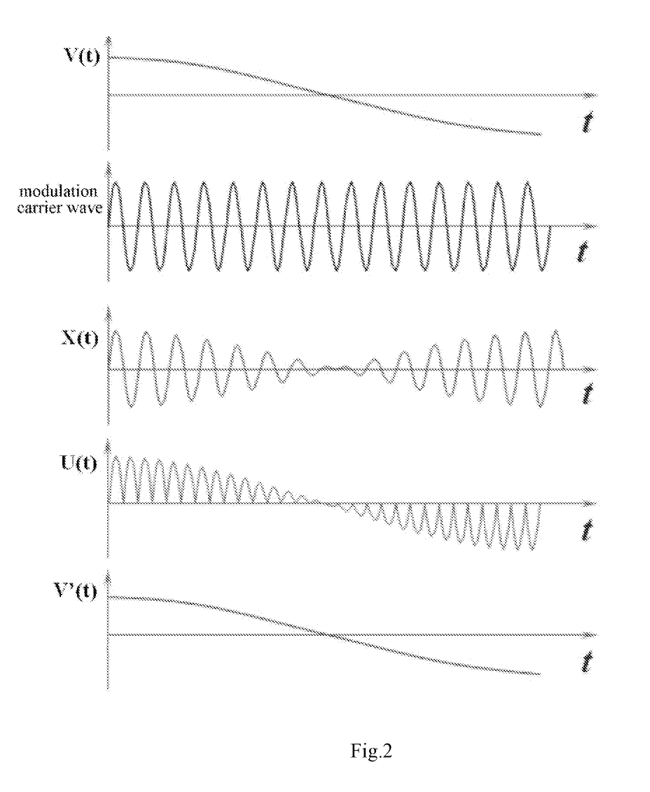

As shown in FIG. 2, the original signal to be modulated is V(t), that is, the intensity of the signal at a time t is V(t), which is equivalent to a frequency-independent sensing signal generated by the light sensing unit 1 when the modulation signal generation unit of the present disclosure is not used.

V(t) is modulated using a sine wave (modulation carrier wave) at a specific frequency to obtain a modulated signal X(t)=V(t)×cos(ω₀t+θ₀), wherein ω₀ is the angular frequency of the sine wave, and θ₀ is the initial phase thereof. X(t) is equivalent to a sensing signal generated by the light sensing unit 1 after the light emitting unit is controlled by the modulation signal of the present disclosure. Of course, the sensing signal at that time actually further includes a lot of frequency-independent noise signals which are not shown in the figure.

X(t) is demodulated using a carrier wave at the same frequency to obtain a demodulated signal U(t)=X(t)×cos(ω₀t+θ₁)×Vr×cos(ω₀t−θ₁), wherein Vr is an artificially set amplitude, and θ₁ is the initial phase of the demodulation carrier wave. θ₁=θ₀ may be set for convenience. Accordingly, U(t)=0.5 Vr×V(t)+0.5 Vr×V(t)×cos(2ω₀t+2θ₀) can be further obtained. If there are noise signals that do not coincide with the modulation frequency in X(t), they would be removed and cannot go into U(t), i.e. they cannot go into the demodulated signal.

Thereafter, U(t) is subjected to low pass filtering so that a restored signal V′(t) is obtained which is substantially the same as the signal V(t) except that it is amplified by a certain multiple with respect to the signal V(t), and the noise signals in X(t) have been removed.

In an exemplary embodiment, the light sensing unit is a light sensing unit configured to generate a sensing current signal. In such an embodiment, the fingerprint recognition component further comprises a current-voltage conversion unit connected between the light sensing unit and the demodulation unit.

During fingerprint recognition, the light sensing unit generally generates a current signal. For example, the light sensing unit 1 may be a photodiode, a phototransistor, a photoresistor, or the like. As shown in FIG. 3, since it is difficult to directly process the current signal, a current-voltage conversion unit (IV conversion circuit) may be provided to convert it into a voltage signal. The current-voltage conversion unit may take a variety of different forms, for example, it employs the circuit shown in FIG. 4, wherein the bias and offset currents of the amplifier in the figure should be very small in order to avoid the distortion of the sensing signal, which need to be, for example, at least two orders of magnitude smaller than the sensing signal.

In an exemplary embodiment, the demodulation unit comprises: a DC blocking subunit, an input terminal of the DC blocking subunit connected to the light sensing unit; a demodulation subunit, an input terminal of the demodulation subunit connected to an output terminal of the DC blocking subunit; and a low pass filter subunit, an input terminal of the low pass filter subunit connected to an output terminal of the demodulation subunit.

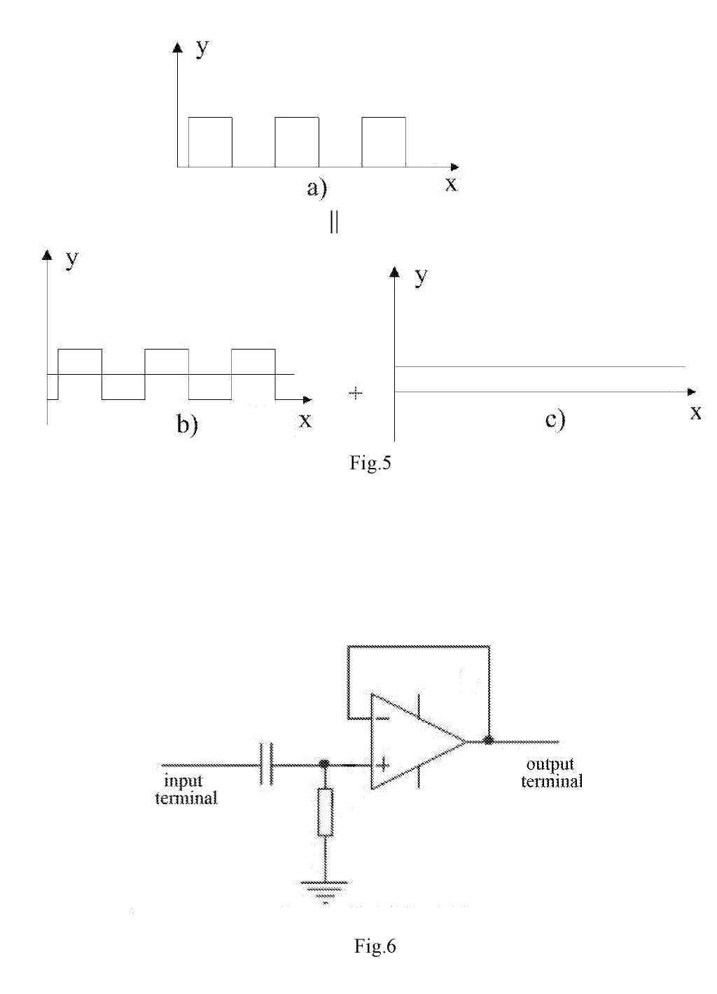

As shown in a) in FIG. 5, the light sensing unit has a forward output when there is illumination, and has no output when there is no illumination, while not having a reverse output. Thus, the generated sensing signal is a one-way square wave signal (regardless of noise), or a signal having a direct current (DC) component. If the signal needs to be demodulated (full-wave phase-sensitive demodulation), the direct current component therein must be removed firstly. Therefore, the DC blocking subunit may be used first to process the sensing signal so as to remove a direct current component b) therefrom and obtain a waveform c). A specific DC blocking subunit may take a variety of different forms, for example, it employs the circuit shown in FIG. 6, which will not be described here in detail. In FIG. 5, the abscissa x represents time, and the ordinate y represents output of the sensing signal of the light sensing unit.

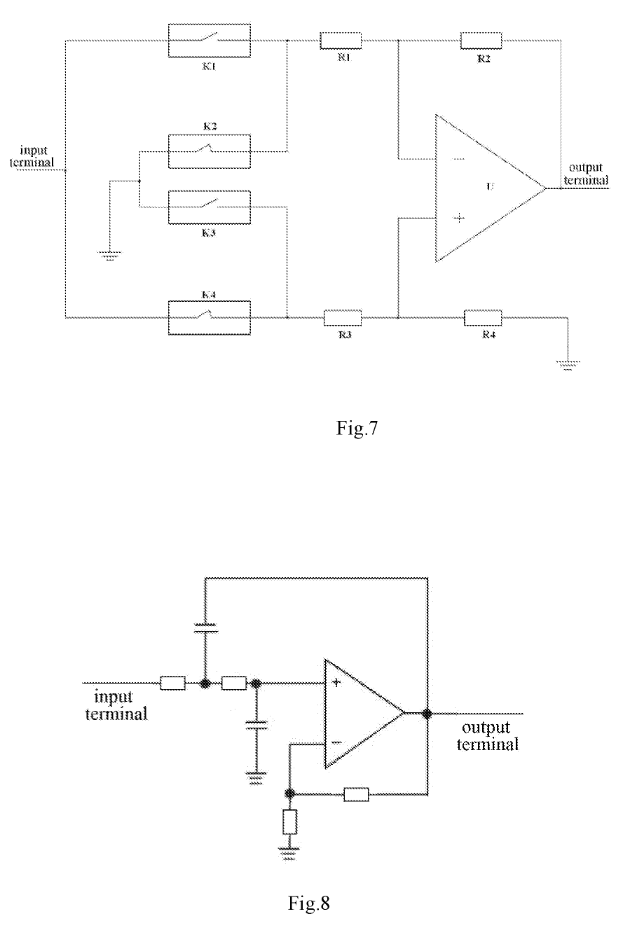

After DC blocking, the demodulation subunit may be used to demodulate the signal. The demodulation subunit may take the form shown in FIG. 7, wherein first terminals of a first switch K1 and a fourth switch K4 are connected to the input terminal of the demodulation subunit and second terminals of the first switch K1 and the fourth switch K4 are connected to first terminals of a first resistor R1 and a third resistor R3, respectively; first terminals of a second switch K2 and a third switch K3 are connected to a ground terminal and second terminals of the second switch K2 and the third switch K3 are connected to the first terminals of the first resistor R1 and the third resistor R3, respectively; second terminals of the first resistor R1 and the third resistor R3 are connected to a negative input terminal and a positive input terminal of an amplifier, respectively; an output terminal of the amplifier is connected to the output terminal of the demodulation subunit, a second resistor R2 is connected between the negative input terminal and the output terminal of the amplifier, and a fourth resistor R4 is connected between the positive input terminal of the amplifier and the ground terminal. Each of the switches is controlled by the demodulation signal (demodulation square wave). The second switch K2 operates in synchronization with the fourth switch K4, the first switch K1 operates in synchronization with the third switch K3, and the status of the second switch K2 is opposite to that of the first switch K 1. Specifically, when the demodulation square wave is at a high level, the second switch K2 and the fourth switch K4 are turned on, the first switch K1 and the third switch K3 are turned off, and the subunit is equivalent to a non-inverting amplifying subunit whose gain is positive. When the demodulation square wave is at a low level, the second switch K2 and the fourth switch K4 are turned off, the first switch K1 and the third switch K3 are turned on, and the subunit is equivalent to an inverting amplifying subunit whose amplification gain is negative. Accordingly, when a signal passes through the circuit, it is “multiplied by” the demodulation square wave, thereby realizing demodulation of the signal. The switches have various specific types (such as thin film transistors of opposite types, the gates of which are all inputted with the demodulation square wave), while the demodulation subunit also has various specific forms, which will not be described here in detail.

Obviously, the above signal resulting from demodulation is still a signal having a modulation frequency, thus it can be subjected to low pass filtering so that it is converted into a stable signal to facilitate subsequent processing. The low pass filtering may take a variety of different forms, for example, it employs the circuit shown in FIG. 8, which will not be described here in detail.

In an exemplary embodiment, the modulation signal generation unit is further connected to the demodulation unit and is further configured to transmit the modulation signal to the demodulation unit as a demodulation carrier signal.

That is, the modulation signal generation unit may also be directly connected to the demodulation unit so that the generated modulation signal is used directly in the demodulation as a demodulation carrier wave (e.g. for controlling the switches in FIG. 7). In this way, it is possible to well ensure that the modulation and demodulation carrier waves have exactly the same waveform and phase, so that the demodulation is most accurate and there is no need to arrange an additional device for generating a demodulation carrier wave. Of course, it is also feasible if the demodulation unit comprises a circuit dedicated to generating a demodulation carrier wave.

In an exemplary embodiment, the modulation frequency is above 1 kHz, for example, between 10 kHz and 100 kHz.

That is, the frequency of the modulation signal (i.e. the frequency at which the light emitting unit flickers) may be within the above range.

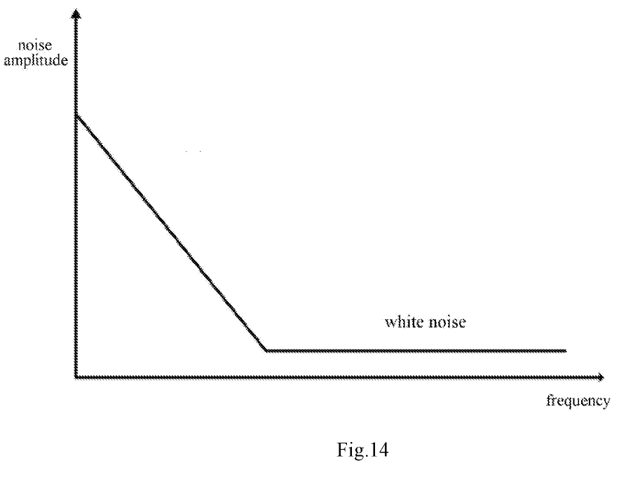

The frequency distribution of the unavoidable noises generated by the circuit itself is shown in FIG. 14, wherein the noises at lower frequency have larger amplitude which decreases with the increasing frequency, while the noises at higher frequency have smaller amplitude and are distributed uniformly with the frequency, which are called “white noises”. The above modulation frequency pertains to the frequency range of the white noises, thus the noises having lower frequency and larger amplitude would be removed upon demodulation. However, in the white noises, the proportion of the noises that just coincide with the modulation frequency is very small, thus most of the white noises would also be removed upon demodulation. Therefore, when the above modulation frequency is used for modulation and demodulation, most of the noises generated by the circuit itself can be removed, which further increases the signal-to-noise ratio of the demodulated signal.

The present embodiment further provides a display device comprising the above-described fingerprint recognition component.

That is, the above-described fingerprint recognition component may be combined with the display device so that the display device also has fingerprint recognition function. Respective light sensing units of individual fingerprint recognition components can be evenly distributed in a display panel of the display device so that fingerprint recognition can be realized at every position of the display panel. Of course, the fingerprint recognition component can also realize touch function at the same time, because it can not only distinguish the fingerprints but also distinguish where the fingers are.

Specifically, the individual light sensing units may be disposed in an array substrate and located at the periphery of pixels for display, for example, they are disposed at the positions where a black matrix resides. Therefore, the light sensing unit takes an incell form, so that it can be better combined with the display device and there is no need to arrange a separate touch substrate, which would not cause a decrease in transmittance.

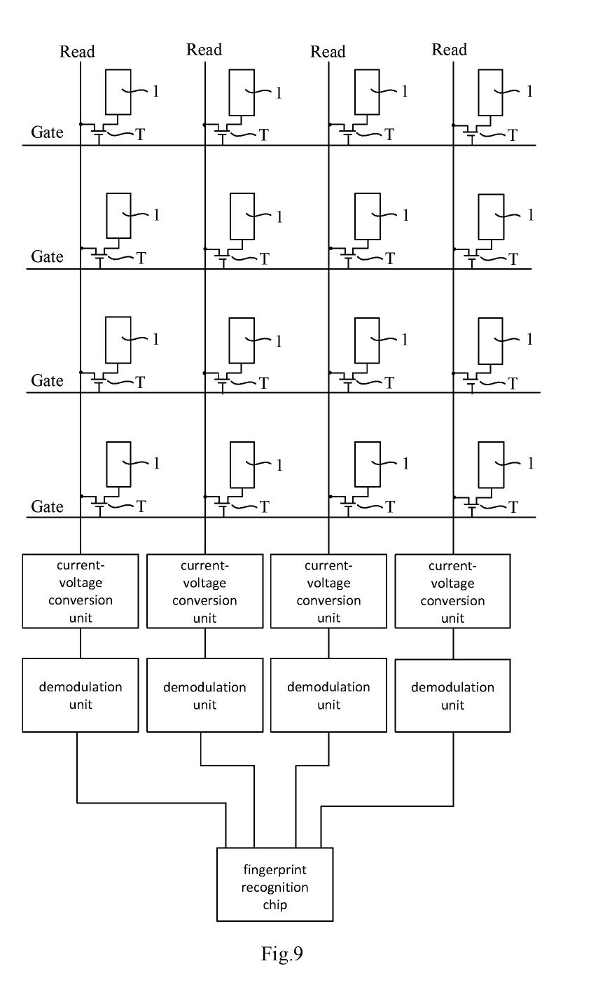

As shown in FIG. 9, light sensing units 1 of the same column can be connected to one read line Read via transistors T, respectively, and gates of the transistors T to which the light sensing units 1 of the same row can be connected to the same control line (e.g. using a gate line Gate), thus the individual light sensing units 1 can output sensing signals in a “scanning” manner similar to that for display, thereby reducing the number of leads. Accordingly, since the light sensing units 1 of the same column output the sensing signals in turn, it is only required to arrange the current-voltage conversion unit and the demodulation unit at an end of each read line Read and then connect them to a fingerprint recognition chip. Consequently, it is possible to reduce the number of devices and leads in the display device while realizing the fingerprint recognition function, thereby simplifying the structure of product and decreasing the cost of product.

As an example implementation of the display device, the display device comprises a liquid crystal display panel including a plurality of pixels, wherein the light sensing unit is disposed in the liquid crystal display panel; a backlight unit disposed outside a light incident surface of the liquid crystal display panel, wherein the backlight unit is a light emitting unit. In such an embodiment, the modulation signal generation unit is connected to the backlight unit and is configured to drive the backlight unit to emit light using the modulation signal generated by the modulation signal generation unit.

That is, the display device may be a liquid crystal display device. Since the light of the liquid crystal display device is from the backlight unit, the backlight unit can be directly used as the above-described light emitting unit and the modulation signal generated by the modulation signal generation unit is used to directly drive the backlight unit so that it emits light flickeringly at the modulation frequency. For example, a PWM circuit (pulse width modulation circuit) may be used as the modulation signal generation unit and used for powering the backlight unit. Thus, the backlight source may emit light flickeringly in accordance with the pulse signal outputted by the PWM circuit. It is to be noted that, since the modulation frequency generated by the modulation signal generation unit is much higher than the frequencies discernable to the human eye, the display effect of the display device would not be affected even if the backlight unit emits light flickeringly while the display device displays content. In fact, generally, as described below, a fingerprint recognition phase and a display phase are time-divisionally performed.

Moreover, the above-described light sensing unit 1 is integrated in the liquid crystal display panel, while the liquid crystal display panel is provided with a lot of structures for display such as electrodes and leads, and all of these structures would affect reflection of light. Therefore, if the light sensing unit is disposed in the liquid crystal display panel, it tends to generate greater noise, so it is difficult to actually realize fingerprint recognition. Therefore, the light sensing unit typically needs to be disposed on a separate touch substrate. However, according to the solution of the present embodiment, the noise can be greatly reduced by modulation and demodulation, so that the integration of the light sensing unit and the liquid crystal display panel becomes possible, thereby simplifying the structure of the display device.

In an exemplary embodiment, the light sensing unit is disposed at an interval between adjacent pixels.

The pixels refer to areas where light for display is actually emitted, between which a black matrix is generally provided. To prevent the light sensing unit from affecting display, the light sensing unit can be disposed at an interval between adjacent pixels. Certainly, when the light sensing unit is disposed at an interval between pixels, it should be ensured that the black matrix would not affect its reception of reflected light (such as removing the black matrix at the position where the light sensing unit resides, or disposing the light sensing unit on a side of the black matrix close to the light exit surface).

Further, the liquid crystal display panel comprises an array substrate and a color film substrate, and the light sensing unit is disposed in the array substrate or the color film substrate.

The liquid crystal display panel is generally formed by performing cell alignment between the array substrate and the color film substrate, thus the light sensing unit 1 may be disposed on the array substrate or the color film substrate. When the light sensing unit is disposed on the array substrate, corresponding leads thereof or the like can be manufactured together with other structures on the array substrate, thus the preparation is simple. When the light sensing unit is disposed on the color film substrate, it is closer to the fingers, and light reflected by the fingers has less divergence, thus the generated signal is more accurate.

As another example implementation of the display device, the display device comprises a plurality of pixels, each including a light emitting unit and a driving unit for driving the light emitting unit to emit light. The driving unit comprises a switching device configured to selectively connect or disconnect the light emitting unit to or from other portions of the driving unit. The modulation signal generation unit is connected to the switching device and is configured to control on or off of the switching device using the modulation signal generated by the modulation signal generation unit.

That is, the display device may also be in the form that respective pixels directly emit light. The pixel includes a light emitting device (i.e. light emitting unit) capable of emitting light and a driving unit for driving the light emitting unit. At the same time, the driving unit is provided with a switching device. When the switching unit is turned on, other portions of the driving unit than the switching unit is connected to the light emitting unit to drive the light emitting unit to emit light. When the switching device is turned off, other portions of the driving unit are disconnected from the light emitting unit, that is, the light emitting unit is not connected to the driving unit and thus does not emit light. Therefore, it is possible to enable the light emitting unit (light emitting device) to emit light flickeringly in accordance with the modulation frequency as long as the switching device is controlled by the modulation signal generated by the modulation signal generation unit.

As a further example implementation of the display device, the display device comprises a light emitting diode display panel. The light emitting diode display panel includes a plurality of pixels, and the light sensing unit is disposed in the light emitting diode display panel.

That is, the display device may also be a light emitting diode display device, so it has a light emitting diode display panel. Accordingly, at that time, the light sensing unit can be integrated in the light emitting diode display panel so as to simplify the structure of the display device.

In an exemplary embodiment, the light sensing unit is disposed at an interval between adjacent pixels.

In an exemplary embodiment, the light emitting diode display panel comprises an array substrate and an opposite substrate, and the light sensing unit is disposed in the array substrate or the opposite substrate.

That is, in the light emitting diode display panel, the light sensing unit is also disposed at an interval between pixels, and also disposed in a certain substrate.

In an exemplary embodiment, each pixel of the light emitting diode display panel includes a light emitting diode and a driving unit for driving the light emitting diode to emit light. The driving unit comprises a switching thin film transistor connected in series with the light emitting diode. When the switching thin film transistor is turned on, the current is allowed to flow through the light emitting diode; when the switching thin film transistor is turned off, the current is not allowed to flow through the light emitting diode. The modulation signal generation unit is connected (including direct or indirect connection) to a gate of the switching thin film transistor.

That is, each pixel of the light emitting diode display panel includes a light emitting diode and a driving unit thereof. The driving unit further comprises a thin film transistor connected in series with the light emitting diode, which is called a switching thin film transistor. Obviously, when the switching thin film transistor is turned on, the current can flow through the light emitting diode, and the light emitting diode may emit light (but it does not necessarily emit light, for example, it may also display pure black). When the switching thin film transistor is turned off, the current cannot flow through the light emitting diode, and the light emitting diode necessarily does not emit light. Accordingly, the switching thin film transistor is used to directly control whether the current can flow through the light emitting diode, or in other words, it is used to directly control whether the light emitting diode can emit light. Moreover, the gate of the switching thin film transistor is further connected to the modulation signal generation unit, so its on and off are controlled by the modulation signal. Therefore, the switching thin film transistor is equivalent to the above-described switching unit, while the light emitting diode is namely the above-described light emitting unit.

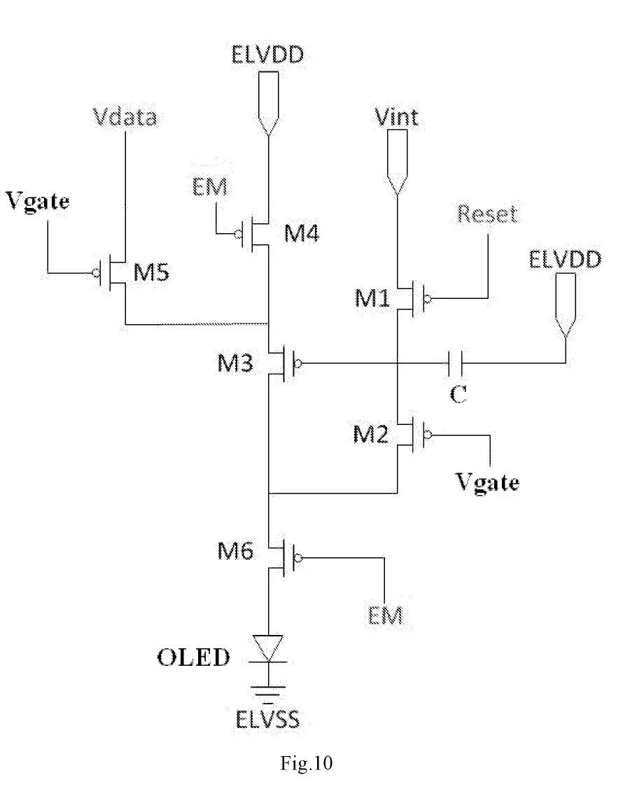

Specifically, a driving unit of a pixel of a light emitting diode display device and its driving timing are as shown in FIG. 10 and FIG. 11, respectively. The driving unit is used for driving the light emitting diode and comprises a first thin film transistor Ml, a second thin film transistor M2, a third thin film transistor M3, a fourth thin film transistor M4, a fifth thin film transistor M5, a sixth thin film transistor M6, and a capacitor C. Individual components in the driving unit are controlled by different signals, respectively. One terminal of the sixth thin film transistor M6 is connected to the anode of the light emitting diode, and the gate of the sixth thin film transistor M6 is connected to an EM signal. Thus, the sixth thin film transistor M6 can just serve as the above-described switching thin film transistor (switching device). The component that generates an EM signal is the modulation signal generation unit. During the fingerprint recognition phase, it is possible to enable the light emitting diode to emit light flickeringly as long as the EM signal is used as a modulation signal having a modulation frequency.

It is to be understood that pixels of different rows begin to display at different times, thus the signals such as Reset, Vgate, etc in their driving units are not synchronized. However, in general, since the entire display device needs to enter the fingerprint recognition phase synchronously, the EM signals in the driving units of different pixels should be changed into modulation signals simultaneously. The fingerprint recognition phase occurs in various manners, which may occur alternately with a display phase in a predetermined manner, and may also occur when a specific program is being run or a specific operation is being performed.

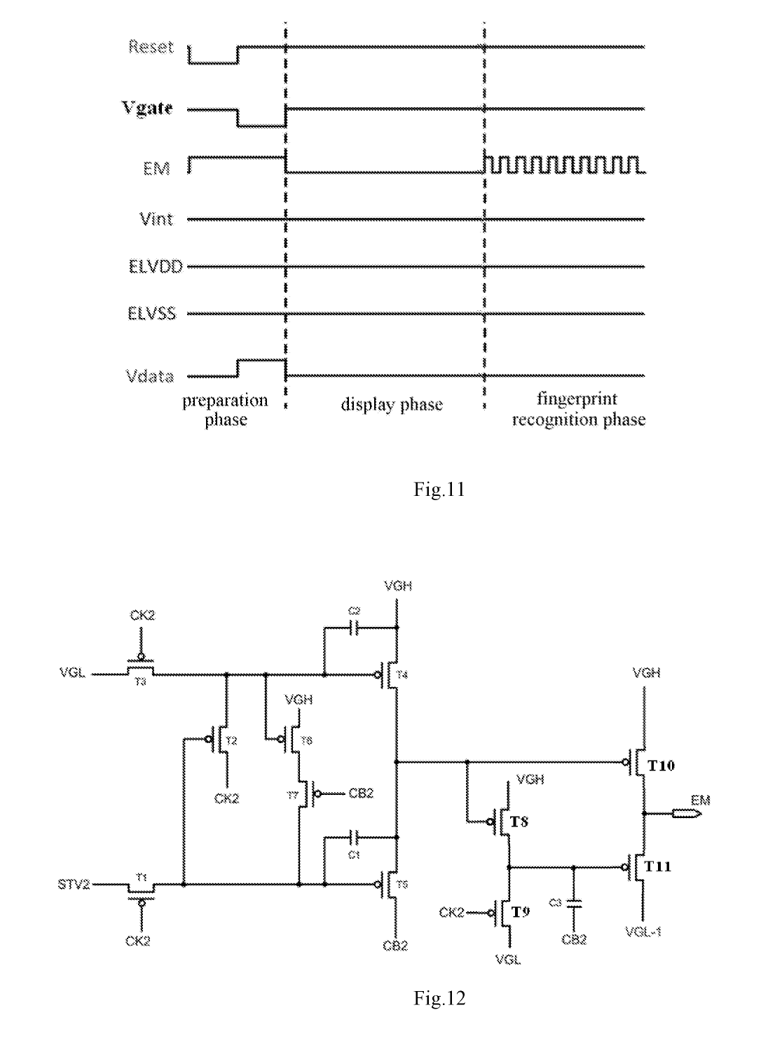

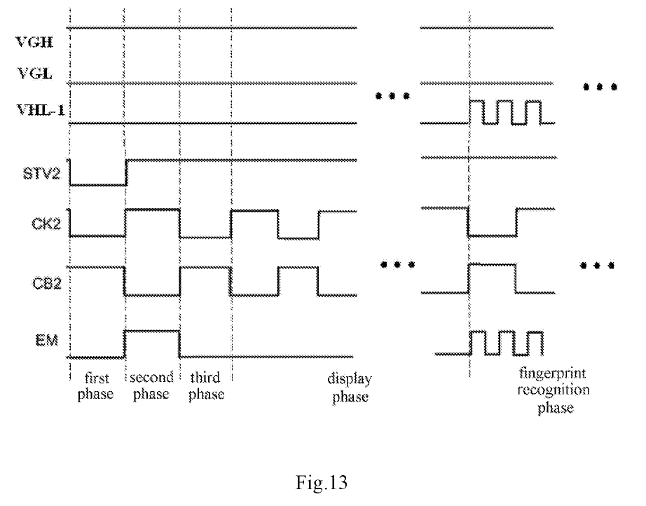

To achieve the above purpose, a shift register for generating an EM signal and a driving timing may be as shown in FIG. 12 and FIG. 13, respectively. Multiple shift registers are cascaded, and each shift register provides EM signals for one row of pixels. Specifically, the shift register comprises a first transistor T1, a second transistor T2, a third transistor T3, a fourth transistor T4, a fifth transistor T5, a sixth transistor T6, a seventh transistor T7, an eighth transistor T8, a ninth transistor T9, a tenth transistor T10, an eleventh transistor T11, a first capacitor C1, a second capacitor C2, and a third capacitor C3. Individual components in the shift register are connected to different signals, respectively. The difference between said shift register and the existing shift register only lies in that VGL and VGL−1 in the existing shift register are the same signal, while the two signals in the shift register of the present embodiment are different, that is, one lead is added to power the shift register. Specifically, as shown in FIG. 13, the VGL signal and the VGL−1 signal are the same in phases other than the fingerprint recognition phase, both of which are at a low level. However, when going to enter the fingerprint recognition phase, it is possible to change all the EM signals in the individual pixels into modulation signals having a modulation frequency as long as the VGL−1 signal is changed into a signal having a modulation frequency, thereby enabling the individual light emitting units (light emitting diodes) to simultaneously emit light flickeringly. It can be seen that, at that time, the shift register and a unit (i.e. driving chip) for generating the VGL−1 signal together serve as the modulation signal generation unit.

Of course, the driving unit, the modulation signal generation unit, and the like as described above all have various specific forms as long as the driving unit has a switching device capable of controlling the light emitting unit, and the switching device can be controlled by the modulation signal generation unit.

The light emitting diode referred to in the above embodiment may be an OLED (organic light emitting diode) or a QLED (quantum dot light emitting diode). The light emitting diodes serve as pixel units and are arranged in an array for displaying images.

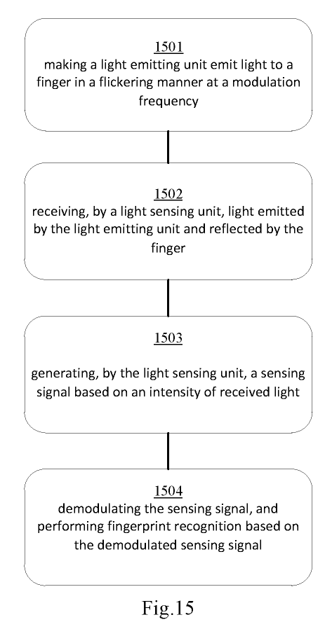

The present embodiment further provides a fingerprint recognition method comprising, as shown in FIG. 15, in step 1501 making a light emitting unit emit light to a finger in a flickering manner at a modulation frequency; in step 1502, receiving, by a light sensing unit, light emitted by the light emitting unit and reflected by the finger; in step 1503, generating, by a light sensing unit, a sensing signal based on the intensity of received light; and in step 1504, demodulating the sensing signal and performing fingerprint recognition based on the demodulated sensing signal.

That is, it is possible to enable the light emitting unit to emit light flickeringly in accordance with the modulation frequency (e.g. under the control of the modulation signal), receive, by the light sensing unit, light reflected by the finger in the flickeringly light-emitting state, demodulate the sensing signal generated by the light sensing unit, and finally perform fingerprint recognition based on the demodulated sensing signal.

Of course, the fingerprint recognition method may be carried out by the fingerprint recognition component or the display device described above.

It is to be understood that the above embodiments are merely exemplary embodiments used for the purpose of illustrating the principles of the present disclosure; however, the present disclosure is not so limited. Various modifications and improvements may be made by those ordinarily skilled in the art without departing from the spirit and essence of the present disclosure, which are also regarded to be within the scope of the present disclosure.

1. A fingerprint recognition component, comprising:
a light emitting unit configured to emit light to a finger;
a light sensing unit configured to receive light emitted by the light emitting unit and reflected by the finger, and generate a sensing signal based on an intensity of received light;
a modulation signal generation unit configured to generate a modulation signal having a modulation frequency, and control the light emitting unit to emit light flickeringly at the modulation frequency by using the modulation signal; and
a demodulation unit connected to the light sensing unit and configured to demodulate the sensing signal in accordance with the modulation frequency.

2. The fingerprint recognition component according to claim 1, wherein the demodulation unit comprises:
a DC blocking subunit, an input terminal of which is connected to the light sensing unit;
a demodulation subunit, an input terminal of which is connected to an output terminal of the DC blocking subunit; and
a low pass filter subunit, an input terminal of which is connected to an output terminal of the demodulation subunit.

3. The fingerprint recognition component according to claim 1, wherein the light sensing unit is a light sensing unit configured to generate a sensing current signal, and the fingerprint recognition component further comprises:
a current-voltage conversion unit connected between the light sensing unit and the demodulation unit.

4. The fingerprint recognition component according to claim 1, wherein
the modulation signal generation unit is further connected to the demodulation unit, and is further configured to transmit the modulation signal to the demodulation unit as a demodulation carrier signal.

5. The fingerprint recognition component according to claim 1, wherein
the modulation frequency is above 1 kHz.

6. A display device, comprising:
the fingerprint recognition component according to claim 1.

7. The display device according to claim 6, comprising:
a liquid crystal display panel including a plurality of pixels, the light sensing unit being disposed in the liquid crystal display panel;
a backlight unit disposed outside a light incident surface of the liquid crystal display panel, the backlight unit being the light emitting unit,
wherein the modulation signal generation unit is connected to the backlight unit and is configured to drive the backlight unit to emit light using a modulation signal generated by the modulation signal generation unit.

8. The display device according to claim 7, wherein
the light sensing unit is disposed at an interval between adjacent pixels.

9. The display device according to claim 7, wherein
the liquid crystal display panel comprises an array substrate and a color film substrate, and the light sensing unit is disposed in the array substrate or the color film substrate.

10. The display device according to claim 6, comprising:
a light emitting diode display panel including a plurality of pixels, the light sensing unit being disposed in the light emitting diode display panel.

11. The display device according to claim 10, wherein
each of the pixels includes a light emitting diode and a driving unit for driving the light emitting diode to emit light;
the driving unit comprises a switching thin film transistor connected in series with the light emitting diode;
a current is allowed to flow through the light emitting diode when the switching thin film transistor is turned on;
a current is not allowed to flow through the light emitting diode when the switching thin film transistor is turned off; and
the modulation signal generation unit is connected to a gate of the switching thin film transistor.

12. The display device according to claim 10, wherein
the light sensing unit is disposed at an interval between adjacent pixels.

13. The display device according to claim 10, wherein
the light emitting diode display panel comprises an array substrate and an opposite substrate, and the light sensing unit is disposed in the array substrate or the opposite substrate.

14. The display device according to claim 6, comprising:
a plurality of pixels, each including the light emitting unit and a driving unit for driving the light emitting unit to emit light,
wherein,
the driving unit comprises a switching device configured to selectively connect or disconnect the light emitting unit to or from other portions of the driving unit; and
the modulation signal generation unit is connected to the switching device and is configured to control on or off of the switching device using a modulation signal generated by the modulation signal generation unit.

15. A fingerprint recognition method, comprising:
making a light emitting unit emit light to a finger in a flickering manner at a modulation frequency;
receiving, by a light sensing unit, light emitted by the light emitting unit and reflected by the finger;
generating, by the light sensing unit, a sensing signal based on an intensity of received light; and
demodulating the sensing signal, and performing fingerprint recognition based on the demodulated sensing signal.

16. The display device according to claim 6, wherein the demodulation unit comprises:
a DC blocking subunit, an input terminal of which is connected to the light sensing unit;
a demodulation subunit, an input terminal of which is connected to an output terminal of the DC blocking subunit; and
a low pass filter subunit, an input terminal of which is connected to an output terminal of the demodulation subunit.

17. The display device according to claim 6, wherein the light sensing unit is a light sensing unit configured to generate a sensing current signal, and the fingerprint recognition component further comprises:
a current-voltage conversion unit connected between the light sensing unit and the demodulation unit.

18. The display device according to claim 6, wherein
the modulation signal generation unit is further connected to the demodulation unit, and is further configured to transmit the modulation signal to the demodulation unit as a demodulation carrier signal.

19. The display device according to claim 6, wherein
the modulation frequency is above 1 kHz.
